(19) United States
(12) Patent Application Publication
(10) Pub. No.: US 2015/0003979 A1
(43) Pub. Date: Jan. 1, 2015

(54) STEAM TURBINE NOZZLE VANE ARRANGEMENT AND METHOD OF MANUFACTURING

(71) Applicant: General Electric Company, Schenectady, NY (US)

(72) Inventor: Fred Thomas Willett, JR., Burnt Hills, NY (US)

(21) Appl. No.: 13/932,603

(22) Filed: Jul. 1, 2013

(51) Int. Cl. F01D 9/04; B23P 15/04; F01D 5/22

(52) U.S. Cl. CPC F01D 9/042; F01D 5/22; B23P 15/04
USPC 415/209.3; 29/889.2

(57) ABSTRACT

A steam turbine nozzle vane arrangement includes a first nozzle vane comprising a first radially outer end and a first radially inner end, the first nozzle vane located in a steam turbine housing and operatively coupled to the steam turbine housing proximate the first radially outer end. Also included is a second nozzle vane operatively coupled to the steam turbine housing proximate a second radially outer end, the second nozzle vane located adjacent the first nozzle vane in a circumferentially aligned turbine stage. Further included is a first cover located proximate the first radially inner end and having a first hole. Yet further included is a second cover located proximate a second radially inner end of the second nozzle vane and having a second hole. Also included is a pin disposed within the first and second hole, the pin configured to fixedly couple the first and second nozzle vanes.

### BACKGROUND OF THE INVENTION

The subject matter disclosed herein relates to steam turbine systems, and more particularly to a steam turbine nozzle vane arrangement, as well as a method of manufacturing such an arrangement.

Steam turbine assemblies use nozzle stages, or rows, comprised of several individual nozzle vanes for the stationary portion of the steam path. The vanes are inserted into a dovetail slot at the outer radius of a shell, casing, or ring, depending on the particular design and method of construction. The steam turbine is designed such that the nozzle assembly behaves as a bladed ring and it is undesirable for the vanes to be uncoupled from one another and be free to move independently from each other. To avoid uncoupling, reduction or prevention of relative motion, including sliding, at the nozzle root is sought. One way to reduce or prevent such relative motion is to ensure a significant contact force at the root surface such that a large friction force must be overcome in order to initiate sliding.

A significant contact force is produced in two ways, typically in combination with each other. Namely, an interference fit is used at the nozzle root and a pre-twist of the nozzle vane is imposed to create a spring force. While initially effective, some drawbacks exist with such designs. Use of an interference fit may result in distortion of the rings to which the vanes are coupled. A distorted ring gradually becomes non-circular and clearances are not uniform around the circumference, leading to open spots, rubs, and performance loss. The pre-twist noted above refers to vanes produced with an airfoil profile rotated slightly out of position. Upon assembly of the vanes into a ring, they are compressed circumferentially and the vane is twisted into its proper shape. The vane itself becomes a torsional spring. The spring force is reacted at the nozzle cover, or inner band. However, the vanes are subjected to high temperatures in the steam turbine and over time the vane material creeps. Since the applied load is due to the spring force, the vane relaxes over time and loses its elasticity. At some point, there is no longer enough friction force at the covers to prevent the vanes from sliding. A solution to this problem is to use creep-resistant material in the early stages of the steam turbine, where temperatures are the highest. Such materials are costly. In particular, creep-resistant material is significantly more expensive than steel that may be otherwise used. The excessive cost is based on raw material cost, as well as costs associated with machining challenges.

### BRIEF DESCRIPTION OF THE INVENTION

According to one aspect of the invention, a steam turbine nozzle vane arrangement includes a first nozzle vane comprising a first radially outer end and a first radially inner end, the first nozzle vane located in a steam turbine housing and operatively coupled to the steam turbine housing proximate the first radially outer end. Also included is a second nozzle vane operatively coupled to the steam turbine housing proximate a second radially outer end, the second nozzle vane located adjacent the first nozzle vane in a circumferentially aligned turbine stage. Further included is a first cover located proximate the first radially inner end and having a first hole. Yet further included is a second cover located proximate a second radially inner end of the second nozzle vane and having a second hole. Also included is a pin disposed within the first hole and the second hole, the pin configured to fixedly couple the first nozzle vane and the second nozzle vane.

According to another aspect of the invention, a steam turbine includes a housing defining a turbine section of the steam turbine. Also included is a plurality of nozzle vane stages, wherein at least one of the plurality of nozzle vane stages includes a plurality of nozzle vanes operatively coupled to the housing proximate a radially outer end of the plurality of nozzle vanes. The nozzle stage also includes a plurality of covers located proximate a radially inner end of the plurality of nozzle vanes. The nozzle stage further includes a plurality of pins, each of the plurality of pins fittingly disposed within at least one hole of the plurality of covers and configured to fixedly couple the plurality of nozzle vanes.

According to yet another aspect of the invention, a method of manufacturing a steam turbine nozzle vane arrangement is provided. The method includes forming a first hole in a first cover of a first nozzle vane. The method also includes forming a second hole in a second cover of a second nozzle vane. The method further includes inserting a spring pin into the first hole, wherein the spring pin is configured to compress upon insertion to provide an interference fit therebetween. The method yet further includes fixedly coupling the first nozzle vane and the second nozzle vane upon insertion of the spring pin into the second hole.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of a plurality of stages of a steam turbine;

FIG. 2 is a perspective view of a first nozzle vane of the steam turbine;

FIG. 3 is a perspective view of a second nozzle vane of the steam turbine;

FIG. 4 is a perspective view of a pin according to a first embodiment;

FIG. 5 is a perspective view of the pin according to a second embodiment;

FIG. 6 is a partially cross-sectional view of the first nozzle vane and the second nozzle vane in a coupled condition; and

FIG. 7 is a flow diagram illustrating a method of manufacturing a steam turbine nozzle vane arrangement.

The detailed description explains embodiments of the invention, together with advantages and features, by way of example with reference to the drawings.

### DETAILED DESCRIPTION OF THE INVENTION

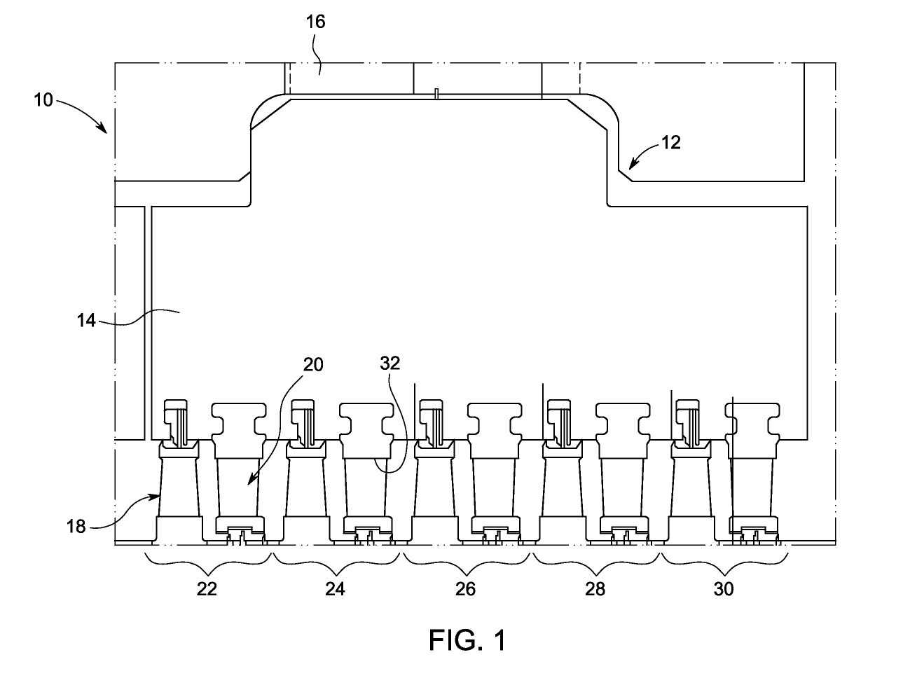

Referring to FIG. 1, a cross-sectional view of a portion of a steam turbine 10 is illustrated. The steam turbine 10 includes a housing structure generally referred to with numeral 12. The particular structure of the housing structure 12 may vary depending on the particular construction of the steam turbine 10. In the illustrated embodiment, the housing structure 12 includes an outer ring 14 fixedly coupled to an outer shell 16, with both the outer ring 14 and the outer shell 16 extending circumferentially in a substantially circular geometry. The housing structure 12 may be divided into segments to form an entire circumferential perimeter. In a typical embodiment, the outer ring 14 and/or the outer shell 16 may be formed as two halves that are operatively coupled during an assembly process.

The steam turbine 10 has a rotor (not illustrated) comprising a plurality of rotor blades 18 operatively coupled thereto. The plurality of rotor blades 18 are arranged in a plurality of rows, with each row having a plurality of circumferentially aligned rotor blades. Interposed between the rows of rotor blades are a plurality of stator vanes 20 (also referred to as “nozzle vanes” herein) operatively coupled to the housing structure 12. The plurality of stator vanes 20 are arranged in a plurality of rows, with each row having the plurality of stator vanes 20 circumferentially aligned. Together, a row of the rotor blades and a row of the stator blades form a stage of the steam turbine 10. For illustration purposes, five stages are shown. Specifically, a first stage 22, a second stage 24, a third stage 26, a fourth stage 28 and a fifth stage 30 are illustrated. It is to be appreciated that greater or fewer stages may be present, depending on the particular application of use.

The plurality of stator vanes 20 are coupled to the housing structure 12 proximate a radially outer end 32 of each of the plurality of stator vanes 20. In the illustrated embodiment, the plurality of stator vanes 20 are coupled to the outer ring 14 via a slot that may take on a “dovetail” shape, as shown. As described above, the particular construction of the housing structure 12 may vary, such that the plurality of stator vanes 20 may be coupled to a shell, a casing or a ring. Furthermore, it is to be appreciated that each of these features may be segmented into inner and outer components. The embodiments described herein may be employed in any housing structure 12 configuration. Irrespective of the precise configuration, the plurality of stator vanes 20 are coupled to an outer structure proximate the radially outer end 32. The plurality of stator vanes 20 extend radially inwardly toward the rotor, with the geometry, positioning and dimensions of the plurality of stator vanes 20 possibly varying from stage to stage.

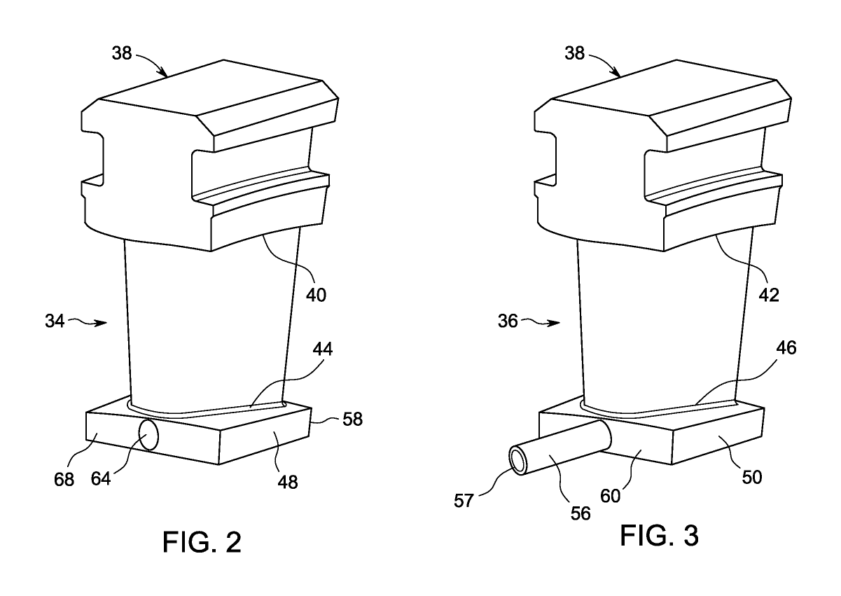

Referring to FIGS. 2 and 3, a first stator vane 34 and a second stator vane 36 are illustrated in greater detail. The first stator vane 34 and the second stator vane 36 are adjacent stator vanes within a common stage of the steam turbine 10 and each include a mounting structure 38 for coupling to the housing structure 12, such as a dovetail slot feature, as noted above. Respectively, the first stator vane 34 and the second stator vane 36 are operatively coupled to the housing structure 12 proximate a first radially outer end 40 and a second radially outer end 42. Operatively coupled to, or integrally formed with, a first radially inner end 44 and a second radially inner end 46 is a first cover 48 and a second cover 50, which in combination with several other covers forms an inner band.

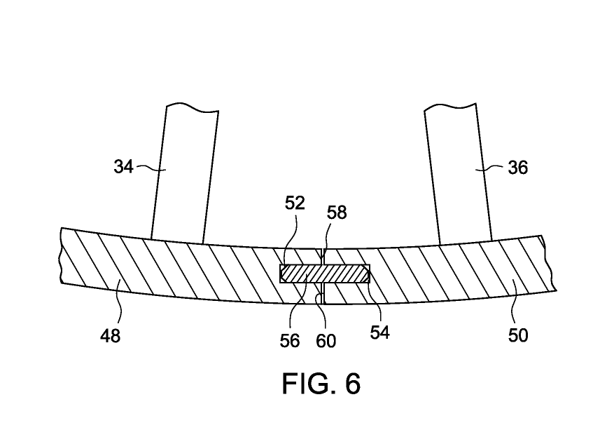

The first cover 48 includes a first hole 52 (FIG. 6), while the second cover 50 includes a second hole 54, together forming a pair of holes. While substantially square covers are illustrated, it is to be appreciated that various other shapes may be employed, depending upon the number, size and shape of the associated stator vanes. A pin 56 is configured to be inserted into the first hole 52 and the second hole 54 to facilitate coupling of the first stator vane 34 to the second stator vane 36 in a tight, fitted arrangement. In one embodiment, the first hole 52 and the second hole 54 each comprise a blind hole that extends only partially through the first cover 48 and the second cover 50 to a predetermined depth, best shown in the illustrated embodiment of FIG. 6. In such an embodiment, the first hole 52 extends inwardly into a first side 58 of the first cover 48 and the second hole 54 extends inwardly into a second side 60 of the second cover 50. Alternatively, the first hole 52 and/or the second hole 54 are through holes extending through the first cover 48 and the second cover 50, respectively. In addition to the above-described first pair of holes, additional pairs of holes configured to fixedly receive additional pins are disposed on opposing sides of respective covers, such as a third hole 64 shown on the third side 68 of the first cover 48.

The pin 56 is configured to be inserted into the first hole 52 and the second hole 54 to secure the adjacent stator vanes to each other, specifically the first stator vane 34 and the second stator vane 36. The pin 56 may be a solid pin in the illustrated cylindrical geometry. A solid pin may be precisely dimensioned to form a tight, fitted engagement with the first hole 52 and the second hole 54. In such an embodiment, the pin 56 may be press fit into the first hole 52 and the second hole 54. Alternatively, the pin 56 is resilient member that is formed of a compliant and/or resilient material and is structurally configured to compress and/or deflect. In such an embodiment, the pin 56 may be referred to as a spring pin. The spring pin comprises an outer diameter that greater than a diameter of the first hole 52 and the second hole 54. In this way, insertion of the spring pin compresses the spring pin and forms a contact interference condition between the pin 56 and the holes. The pin 56 applies continuous pressure towards the sides of the hole walls, which provides tension in a radial manner to reduce or prevent loosening.

Any of the embodiments of the pin 56 described herein may include a chamfer portion 57 on either or both ends of the pin 56 to facilitate insertion of the pin 56 into the first hole 52 and the second hole 54. Alternatively, the holes may include a chamfer portion configured to provide a lead-in surface for the pin 56.

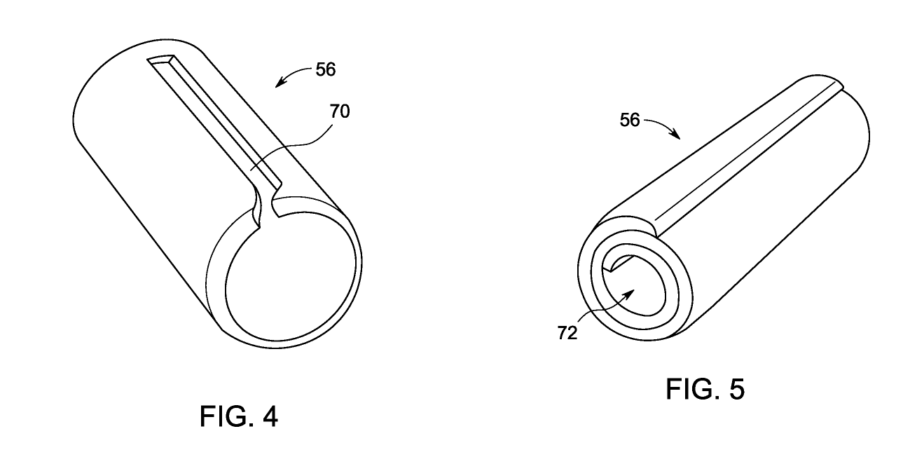

Referring to FIG. 4, the pin 56 is a spring pin according to a first embodiment. The pin 56 is a slotted spring pin that is a hollow, cylindrical tube having a longitudinal slot 70 extending along all or a portion of the length of the spring pin. Upon insertion to the first hole 52 and the second hole 54, the longitudinal slot 70 facilitates deflection and overall compression of the pin 56.

Referring to FIG. 5, the pin 56 is a spring pin according to a second embodiment. The pin 56 is a spiral pin comprising at least one segment of rolled material with a hollow portion 72 extending therethrough. The spiral configuration of the pin 56 facilitates compression of the pin 56 upon relative sliding of various layers of the rolled material.

The embodiments of the pin 56 described herein may be formed of various materials configured to withstand the operational conditions of the steam turbine 10. Regardless of the material employed, the spring pin will relax after time at high temperature, however, the relaxed condition of the pin 56 reduces or prevents relative motion of adjacent stator vanes, such as the first stator vane 34 and the second stator vane 36, due to the interference condition imposed between the surfaces of the pin 56 and the hole walls, which results from the larger diameter of the pin 56 with respect to the holes, as described in detail above. In one embodiment, the pin 56 is formed of a creep resistant material to reduce deformation of the pin 56 over time. Those skilled in the art will appreciate suitable creep-resistant materials, such as a nickel-chromium-based superalloy. For example, Inconel™ 625 may be employed. Forming the pin 56 of such a material represents a significant cost savings over a steam turbine comprising stator vanes formed of creep resistant material.

Referring to FIG. 6, the first stator vane 34 and the second stator vane 36 are illustrated in a coupled condition. As shown, the pin 56 fixedly couples the first stator vane 34 and the second stator vane 36 upon insertion of the pin 56 into the first hole 52 and the second hole 54 of the respective first cover 48 and the second cover 50. It is to be appreciated that an entire row of stator vanes may be operatively coupled with a plurality of pins disposed in a plurality of holes of a plurality of covers. Such an arrangement provides a continuous coupling of the stator vanes to advantageously reduce or prevent relative motion of the stator vanes. In one embodiment, an entire first half of the stator vane row is operatively coupled to an entire second half of the stator vane row to form a continuous, 360° row of coupled stator vanes.

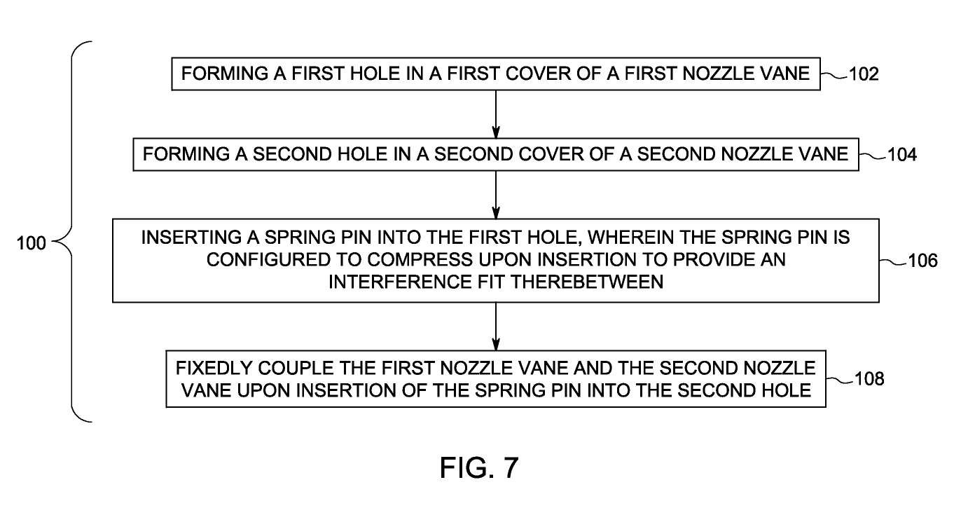

As illustrated in the flow diagram of FIG. 7, and with reference to FIGS. 1-6, a method of manufacturing a steam turbine nozzle vane arrangement 100 is also provided. The steam turbine 10, as well as the stator vanes therein, has been previously described and specific structural components need not be described in further detail. The method of manufacturing a steam turbine nozzle vane arrangement 100 includes forming a first hole in a first cover of a first nozzle vane 102. A second hole is formed in a second cover of a second nozzle vane 104. A spring pin is inserted into the first hole, wherein the spring pin is configured to compress upon insertion to provide an interference fit therebetween 106. The first nozzle vane is fixedly coupled to the second nozzle vane upon insertion of the spring pin into the second hole 108.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A steam turbine nozzle vane arrangement comprising:
a first nozzle vane comprising a first radially outer end and a first radially inner end, the first nozzle vane located in a steam turbine housing and operatively coupled to the steam turbine housing proximate the first radially outer end;
a second nozzle vane operatively coupled to the steam turbine housing proximate a second radially outer end, the second nozzle vane located adjacent the first nozzle vane in a circumferentially aligned turbine stage;
a first cover located proximate the first radially inner end and having a first hole;
a second cover located proximate a second radially inner end of the second nozzle vane and having a second hole; and
a pin disposed within the first hole and the second hole, the pin configured to fixedly couple the first nozzle vane and the second nozzle vane.

2. The steam turbine nozzle vane arrangement of claim 1, wherein each of the first hole and the second hole comprises a blind hole.

3. The steam turbine nozzle vane arrangement of claim 1, wherein the pin comprises a solid cylindrical pin.

4. The steam turbine nozzle vane arrangement of claim 1, wherein the pin comprises a spring pin configured to compress upon insertion to the first hole and the second hole.

5. The steam turbine nozzle vane arrangement of claim 4, wherein an interference fit between the spring pin and the first hole and the second hole is provided upon insertion of the spring pin.

6. The steam turbine nozzle vane arrangement of claim 4, wherein the spring pin comprises a slot to facilitate compression of the spring pin.

7. The steam turbine nozzle vane arrangement of claim 4, wherein the spring pin comprises a spiral pin.

8. The steam turbine nozzle vane arrangement of claim 1, wherein the pin is formed of a creep resistant material.

9. The steam turbine nozzle vane arrangement of claim 8, wherein the creep resistant material comprises a nickel-chromium-based superalloy.

10. A steam turbine comprising:
a housing defining a turbine section of the steam turbine; and
a plurality of nozzle vane stages, wherein at least one of the plurality of nozzle vane stages comprises:
a plurality of nozzle vanes operatively coupled to the housing proximate a radially outer end of the plurality of nozzle vanes;
a plurality of covers located proximate a radially inner end of the plurality of nozzle vanes; and
a plurality of pins, each of the plurality of pins fittingly disposed within at least one hole in the plurality of covers and configured to fixedly couple the plurality of nozzle vanes.

11. The steam turbine of claim 10, wherein the plurality of nozzle vanes fixedly coupled to each other comprises a first half of a nozzle vane stage and a second half of a nozzle vane stage, wherein the first half and the second half are fixed coupled to each other.

12. The steam turbine of claim 10, wherein the at least one hole comprises a pair of blind holes.

13. The steam turbine of claim 10, wherein the plurality of pins comprises a plurality of solid cylindrical pins.

14. The steam turbine of claim 10, wherein each of the plurality of pins comprises a spring pin configured to compress upon insertion into the at least one hole.

15. The steam turbine of claim 14, wherein an interference fit between the spring pin and the at least one hole is provided upon insertion of the spring pin.

16. The steam turbine of claim 14, wherein the spring pin comprises a slot to facilitate compression of the spring pin.

17. The steam turbine of claim 14, wherein the spring pin comprises a spiral pin.

18. The steam turbine of claim 14, wherein the spring pin is formed of a creep resistant material.

19. The steam turbine of claim 18, wherein the creep resistant material comprises a nickel-chromium-based superalloy.

20. A method of manufacturing a steam turbine nozzle vane arrangement, comprising:
forming a first hole in a first cover of a first nozzle vane;
forming a second hole in a second cover of a second nozzle vane;
inserting a spring pin into the first hole, wherein the spring pin is configured to compress upon insertion to provide an interference fit therebetween; and
fixedly coupling the first nozzle vane and the second nozzle vane upon insertion of the spring pin into the second hole.
